(19) United States
(12) Patent Application Publication
(10) Pub. No.: US 2003/0153335 A1
(43) Pub. Date: Aug. 14, 2003

(54) Cellular radio telecommunication systems

(76) Inventors: Nicholas Dougall Johnson, St Albans (GB); Neil Philip Piercy, Royston (GB)

Correspondence Address: Gregory J Lavorgna, Drinker Biddle & Reath, One Logan Square, 18th and Cherry Streets, Philadelphia, PA, 19103-6996, US

(21) Appl. No.: 10/332,887

(22) PCT Filed: Jul. 16, 2001
(86) PCT No.: PCT/GB01/03181

(30) Foreign Application Priority Data
Jul. 14, 2000 (GB) 0017426.8

(51) Int. Cl. H04B 7/005; H04Q 7/20

(52) U.S. Cl. 455/502; 455/524

(57) ABSTRACT

A radio telecommunication system, and in particular an in-building system, comprises a number of basestations connected together by a local area network (LAN) at least one of the basestations (BS) is capable of receiving a control channel transmitted by one or more of the other basestations (BS) of the telecommunication systems, from which it derives frequency reference and time base synchronisation data to enable the basestation to correct the frequency and time offset of its own transmissions with respect to the other basestations (BS) in the system. Also connected to the LAN is a controller (PC). The controller receives transmission measurement signals from each of the basestations (BS) and processes these transmission measurement signals to select radio frequency channels on which the basestations of the system should transmit to minimise interference with an external telecommunications system. The controller (PC) also receives transmission measurement signals from the basestations (BS) that are used to determine the power at which the basestations of the telecommunications system should transmit.

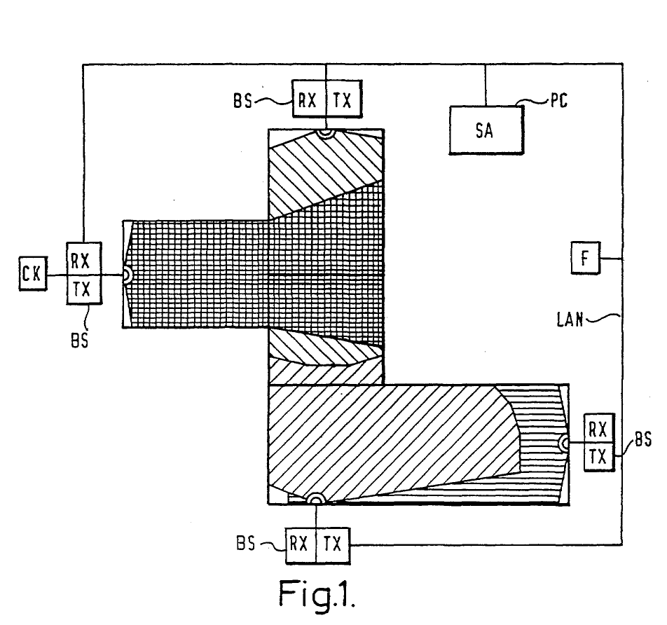

### TECHNICAL FIELD

This invention relates to cellular radio telecommunication systems, and especially to synchronization and power control with the basestations of such systems.

In order for the basestations of cellular telecommunication systems to be able to transmit their signals with sufficient frequency and time accuracy to meet their specification and operate successfully, it is essential that each basestation can access an accurate and stable clock source, to act as a reference for its frequency source and timebase. For example, the GSM standard requires that nominal basestations have a clock which is accurate to within 50 ppb. This is usually achieved by two alternative methods. Either basestations derive an accurate clock from the telecommunication interface (E1 interface) linking them with their core network, or they are equipped with a high accuracy internal clock, usually a high precision oven controlled crystal oscillator (OCXO). For new generations of networks it is desirable to be able to synchronise non-colocated basestations together, which may be easily achieved with a line derived reference from a common interface loop, but cannot be achieved over long timescales using internal (OCXO) references in each basestation, owing to unavoidable drift between crystals.

For in-building systems, where the telecommunications interface is replaced with a LAN connection, the line derived reference is not available. OCXO based solutions are relatively expensive and physically delicate, owing to the complexity of their construction.

In order for the in-building cell planning to succeed with good coverage quality as well as to interfere minimally with external networks, it is important that the in-building network operates at a minimum power, consistent with the level of in-building service provided. Normal methods of ensuring this demand a highly skilled and detailed site survey of the in-building environment, which adds significantly to the installed cost of in-building systems.

This invention addresses both of these issues and aims to provide a less costly alternative to OCXOs in the basestation, and site survey.

### DISCLOSURE OF THE INVENTION

This is achieved according to a first aspect of the invention by providing a basestation in a cellular telecommunication system with a radio receiver which is capable of receiving a control channel transmitted by one or more other basestations of the system, from which it derives frequency reference and timebase synchronisation data to enable it to correct the frequency and time offset of its own transmissions with respect to those of said other basestations.

Preferably, multiple basestations are each provided with a radio receiver to receive a control channel transmitted by the other basestations so as to synchronise the frequency of transmission of all the basestations.

According to a second aspect, the invention consists in a cellular radio telecommunication system comprising multiple basestations which are connected by a local area network to a controller to deliver to it transmission measurement signals indicative of radio signals received by each on a control channel of basestations of an external system, the controller serving to process these transmission measurement signals to select radio frequency channels on which the basestations should transmit to minimise interference with the external system.

According to a third aspect, the invention consists in a cellular radio telecommunication system comprising multiple basestations which are connected by a local area network to a controller to deliver to it transmission measurement signals indicative of radio signals received by each from other of said basestations on a control channel, the controller serving to process these transmission measurement signals in order to determine the power at which the basestations should transmit on said control channel as transmission of the basestations is switched on in a progressive manner.

Preferably, at least one basestation is provided with a clock generator, the frequency of which is adjusted with synchronisation of the basestation and serves to provide a frequency reference which is used to maintain synchronisation of the basestations.

Preferably, the controller designates one basestation as a master basestation which is first switched on to transmit the control channel, and the other basestations synchronise their operation with the master basestation as they are switched on in turn.

Preferably, the master basestation is selected by the controller in accordance with its ability to receive the control channel of an external system with which it can be synchronised.

Preferably, basestations, other than the master basestation, which also receive the control channel of the external system are used to synchronise their operation with the external system.

If a base station receives more than one control channel of an external system, then the derived frequencies of the control channels are averaged for synchronisation.

Mobile subscriber units operating within the system synchronise with the system control channel and thus they carry synchronisation reference frequency with them as they move between cells in the system, which serves to adjust the control channel frequency.

According to a fourth aspect, the invention consists in a cellular telecommunication system including a radio receiver which monitors the frequency of the control channel of the system, an external frequency reference such as a GPS receiver or clock generator, and comparator means to compare the control channel frequency with the external frequency reference and produce a frequency error signal to adjust the frequency of the control channel.

### DESCRIPTION OF THE DRAWING

The invention will now be described by way of example with reference to the accompanying schematic drawing showing a cellular radio telecommunication system according to the invention as applied to an in-building network.

### BEST MODE OF CARRYING OUT THE INVENTION

An important requirement of the network is that it be able to propagate the frequency and timebase information from one master reference basestation, through to all other basestations in the network. This is achieved by equipping each basestation BS with a GSM receiver RX capable of receiving in the GSM downlink band. Additionally, at least one of the basestations is equipped with an intrinsically accurate clock generator CK, for example a clock generator based on GPS, Rugby MSF, Braunchsweig, or high precision OCXO. These base stations equipped with an accurate clock generator are called “holdover capable”.

At first switch on of the network, all the basestations inhibit their transmitters, and they scan the GSM downlink band, looking for other GSM BCCH transmissions. Once BCCHs are found, then the associated system information messages are decoded. Each basestation then reports the results of its scan to a controller PC via a LAN. The controller PC then processes the results to build a frequency plan for the network. Also, once BCCHs are found by the network, the frequency synchronisation information obtained is used to set the operating RF frequency of the network. A “synchronisation agent” SA incorporated in the controller PC provides the required functionality to build the frequency plan and to synchronise the basestations.

On the basis of the BCCH quality and signal strength received and reported by the basestations, the SA selects one basestation to act as master for the network. This master basestation then begins transmitting a GSM beacon on a channel selected by the SA so as to minimise interference with the external network. The other basestations in the network are then instructed to synchronise to the new beacon using the BCCH channel, and to report the received signal strength and quality accordingly. The SA then directs those nearest the master, based on received signal strength and quality, to begin transmission, and the cycle repeats until the whole network is activated. During this procedure, the power levels transmitted by the beacons are set, preferably iteratively, to maintain a certain minimum quality of signal throughout the network, consistent with minimisation of interference with the external network.

In particular, the procedure is as follows:

1. The transmitted power level from any particular basestation is known.

2. The received power level at all other basestations are measured.

3. Steps 1 and 2 are repeated for each basestation in turn.

4. The SA works out the propagation loss between any basestation and any other basestation, this information being captured in a loss matrix, each row of the loss matrix corresponding to the power received at each basestation for a given transmitting basestation transmitting at known power level.

5. The loss matrix is used to set the power levels within the network as follows:

It is desirable to maintain signal level between basestations at some basic minimum level so that any mobile within the coverage area of the basestations receives a guaranteed minimum signal level. The power level is calculated and set at each basestation using the loss matrix so that the received power at a given number (the neighbour number) of basestations is above the basic minimum level. In the case of an in-building network there is an assumption that basestations are disposed within the perimeter of the building, so that mobiles within the building are generally moving within the polygon (or polyhedron) defined by the basestation locations. For best coverage, the average neighbour number for the ensemble of basestations needs to be as high as possible, but to minimise the power and for best frequency re-use within the building, it should be as low as possible. The procedure allows the possibility of trading the number of basestations against the coverage quality, against the average transmitted power. For networks in a dense urban network, a high number of basestations are selected, and the transmit power set so that the ensemble average neighbour number (EANN) is low—between one and two. For more isolated networks with high traffic requirements, the power might be set higher, with a smaller number of basestations, with a higher EANN—giving better trunking efficiency on the air.

If, during the initial scan, a basestation has visibility of more than one beacon channel from more than one operator or a next-nearest neighbour cell, then it averages the frequency measurements it makes to increase the accuracy of its own frequency setting, reporting the enhanced accuracy to the SA.

Also, if during the initial scan, more than one basestation has visibility of the macro network, then those basestations which could acquire synchronisation with the macro network, but which were not selected as master by the SA, are designated “unselected masters”. As the switch on of the network proceeds, each of these unselected masters compares the network beacon frequency with the macro network frequency, and reports the frequency errors to the SA. The SA in turn directs the master to adjust its frequency source, to take account of these extra measurements, and thereby increase accuracy still further.

When frequency synchronisation has been achieved, then the holdover capable basestations will have adjusted their high precision internal references to match the timebase of the network.

The GSM frame timebase of the network is determined by the master basestation at switch on. All other basestations within the network synchronise to it naturally, in the same way that mobiles synchronise their own internal timebases to the network.

Basestations will have limited isolation between downlink transmit and downlink receive channels, and therefore once a basestation in a network has begun transmitting, it is difficult for that basestation to maintain over-the-air synchronisation from downlink monitoring. During normal operation therefore, the network relies on the holdover capable basestations to maintain its frequency accuracy.

Also, during normal operation of a reasonably busy network, each basestation will acquire frequency and timebase information about the network to which it belongs from the uplink bursts from mobiles synchronised to the network. Faults in the frequency synchronisation of individual basestations will be immediately apparent in the frequency and timebase errors reported by basestations on uplink bursts. Mobiles operating in the network will be synchronised to the majority (true) timebase, and so bursts from such mobiles will appear to be in frequency error, though the reality is that the basestation has lost frequency and timing lock with the network. Note that frequency errors are derived by basestations from the raw burst signal transmitted by the mobile, whereas timing errors are most conveniently calculated and reported by the mobile as part of its normal neighbour cell measurement reporting mechanism.

In the GSM case, the frequency accuracy that can be derived from the training sequence of a single burst is not sufficiently high, but by extended, continuous monitoring of a single traffic channel, sufficient bursts can be measured to achieve the required accuracy by averaging.

When the network is not busy, then basestations can be taken off-line (as described in the following paragraph) and can reacquire frequency lock and timebase synchronisation by reception of other basestations' transmissions either in the in-building network, or the external network.

In order to provide good fault detection and fault tolerance, it is necessary to periodically check the operation of each individual basestation and the network as a whole. At a preset interval, possibly daily, possibly more frequently, each basestation in the network is disabled. This involves the handover or other routing of all of its calls through neighbouring basestations and preventing further allocation of its resources. Once the basestation is disabled from transmitting, it once again enters receive mode, and the SA resynchronises it with the remainder of the network and with any macro network beacons it can see. Having resynchronised, it can then re-enter service, and another basestation is scheduled for resynchronisation.

The synchronisation agent SA described above should work well in medium to large sized networks (above 4 or 5 basestations), where the number of co-operating entities ensures a robust, fault tolerant network with high frequency accuracy and inertia.

In a small network, with only one or two basestations, it is more difficult for the SA to maintain frequency synchronisation. Possibly the minimum installation is restricted to two basestations, each of which checks the other.

Alternatively, an IP equipped mobile can be provided which monitors the basestation and the external network continuously, and reports the errors to the SA or basestation to correct its frequency. This is illustrated in the drawing as a unit F comprising a GSM radio receiver which monitors the network operating frequency and a clock source, such as a GPS receiver, and means to compare the frequencies of the network and clock source and produce an error signal which is transmitted over the LAN to the synchronisation agent SA.

1. A cellular telecommunication system comprising a basestation having a radio receiver that is capable of receiving a control channel transmitted by one or more other basestations of the system, from which it derives frequency reference and time base synchronisation data to enable it to correct the frequency and time offset of its own transmissions with respect to those of said other basestations.

2. A cellular telecommunication system according to claim 1, wherein multiple basestations are each provided with a radio receiver to receive a control channel transmitted by the other basestations so as to synchronise the frequency of transmission of all the basestations.

3. A cellular radio telecommunication system comprising multiple basestations that are connected by a local area network, to a controller to deliver to the controller transmission measurement signals indicative of radio signals received by each basestation transmitted on a control channel of an external system, the controller serving to process these transmission measurement signals to select radio frequency channels on which the basestations should transmit to minimise interference with the external system.

4. A cellular radio telecommunication system comprising multiple basestations that are connected by a local area network to a controller to deliver to the controller transmission measurement signals indicative of radio signals received by each basestation from other of said basestations on a control channel, the controller serving to process these transmission measurement signals in order to determine the power at which the basestations should transmit on said control channel as transmission of the basestations is switched on in a progressive manner.

5. A cellular telecommunication system as claimed in claim 4 in which said transmission measurement signals are made in response to transmissions from one basestation at a time.

6. A cellular telecommunication system as claimed in claim 5 in which said transmission measurement signals are used to determine the propagation loss between any pair of basestations, the propagation loss determined for all such pairs of basestations being incorporated into a loss matrix which is used to set the power level of basestations within the network.

7. A cellular telecommunication system according to claim 3 or 4, wherein at least one basestation is provided with a clock generator, the frequency of which is adjusted with synchronisation of the basestation to the control channel and serves to provide a frequency reference which is used to maintain synchronisation of the basestations.

8. A cellular telecommunication system according to claim 7, wherein said clock generator comprises a crystal oscillator or a radio signal corrected clock.

9. A cellular telecommunication system according to claim 3 or 4, wherein the controller designates one basestation as a master basestation which is switched on first to transmit the control channel, and the other basestations synchronise their operation with the master basestation as they are switched on in turn.

10. A cellular telecommunication system according to claim 9, wherein the master basestation is selected by the controller in accordance with its ability to receive the control channel of an external system with which it can be synchronised.

11. A cellular telecommunication system according to claim 9 or 10, wherein basestations, other than the master basestation, which also receive the control channel of the external system are used to synchronise their operation with the external system.

12. A cellular telecommunication system according to claim 11, wherein said master basestation transmits a control channel substantially synchronised to the control channel frequency of the external system.

13. A cellular telecommunication system according to claim 12, wherein said basestations, other than the master basestation, which also receives the control channel of the external system compare the frequency of the received control channel with the frequency of the control channel transmitted by the master basestation to produce an error signal to adjust the frequency of the control channel transmitted by the master basestation.

14. A cellular telecommunication system according to claim 9, wherein if a basestation receives more than one control channel of an external system, then the derived frequencies of the control channels are averaged for synchronisation.

15. A cellular telecommunication system according to any one of claims 3 to 14, wherein a mobile subscriber unit operating within the system synchronises with the system control channel and thus generates a synchronisation reference frequency derivable by each basestation as said mobile subscriber moves between cells in the system, whereby said basestations are arranged to adjust their control channel frequency.

16. A cellular telecommunication system including a radio receiver which monitors the frequency of the control channel of the system, an external frequency reference such as a GPS receiver or clock generator, and comparator means to compare the control channel frequency with the external frequency reference and produce an frequency error signal to adjust the frequency of the control channel.
